(19) United States
(12) Patent Application Publication
(10) Pub. No.: US 2018/0229861 A1
(43) Pub. Date: Aug. 16, 2018

(54) TOOLING FOR HANDLING A NACELLE OF AN AIRCRAFT TURBOJET ENGINE

(71) Applicant: Safran Nacelles, Gonfreville L'Orcher (FR)

(72) Inventors: Pascal LECOUTRE, GONFREVILLE L'ORCHER (FR); Vincent LETARD, GONFREVILLE L'ORCHER (FR)

(73) Assignee: Safran Nacelles, Gonfreville L'Orcher (FR)

(21) Appl. No.: 15/952,391

(22) Filed: Apr. 13, 2018

Related U.S. Application Data
(63) Continuation of application No. PCT/FR2016/052625, filed on Oct. 11, 2016.

(30) Foreign Application Priority Data
Oct. 13, 2015 (FR) 15/59732

(51) Int. Cl. B64F 5/10

(52) U.S. Cl. CPC B64F 5/10

(57) ABSTRACT

The present disclosure provides a tooling for handling a nacelle of an aircraft turbojet engine. The tooling includes a gantry having at least one upper support bar which is hinged about at least a first upper axis of rotation (A) by a first upper hinge. The upper support bar is hinged between at least a first support position in which the upper bar has a first attachment which is adapted to be fastened on a first type of nacelle, and at least a second support position in which the upper support bar has a second attachment which is adapted to be fastened on a second type of nacelle.

### CROSS-REFERENCE TO RELATED APPLICATIONS

This application is a continuation of International Application No. PCT/FR2016/052625, filed on Oct. 11, 2016, which claims priority to and the benefit of FR 15/59732 filed on Oct. 13, 2015. The disclosures of the above applications are incorporated herein by reference.

### FIELD

The present disclosure relates to tooling for handling a nacelle of an aircraft turbojet engine, the tooling allowing the nacelle to be hung, in particular in order to enable an operator to intervene on this nacelle.

### BACKGROUND

The statements in this section merely provide background information related to the present disclosure and may not constitute prior art.

An aircraft is propelled by one or several propulsion unit(s) each comprising a turbojet engine which is housed in a nacelle.

A nacelle presents in general a substantially tubular structure which surrounds the turbojet engine and which comprises an air inlet upstream of the motor, a median section intended to surround a fan of said turbojet engine and a downstream section surrounding the combustion chamber of the turbojet engine and which may be equipped with thrust reversal means.

The handling tooling comprises generally a rolling gantry on which are fastened an upper support bar, and a lower support bar, these bars being intended to be fastened respectively on upper fittings of the nacelle, and on lower locks or stirrups of the nacelle.

Such a tooling should be usable with different types of nacelles.

Indeed, depending on the motorization associated to the nacelle and depending on the presence or absence of some equipment, such as a thrust reverser, the dimensions vary from one nacelle to another.

To date, these different uses have required a dismount/change/remount of the support bars, so that the dimensions of these support bars could correspond to those of the nacelle to handle.

The weight of these support bars being considerable, typically in the order of 30 kg, and the upper bars being located at a high position, their handling has been until then difficult and dangerous.

### SUMMARY

The present disclosure provides tooling for handling a nacelle of an aircraft turbojet engine, the tooling comprising a gantry which includes:

a longitudinal upper support bar adapted to be fastened on upper fasteners of the nacelle; and

a longitudinal lower support bar adapted to be fastened on lower fasteners of the nacelle,

characterized in that the upper support bar is hinged about at least a first upper axis of rotation by a first upper hinge, the upper bar being hinged between at least a first support position in which the upper bar has a first attachment which is adapted to be fastened on a first type of nacelle, and at least a second support position in which the upper support bar has a second attachment which is adapted to be fastened on a second type of nacelle.

This feature enables the upper bar to adopt at least two different positions in order to adapt to the type of nacelle to handle.

According to another feature, the upper support bar is hinged about a second upper axis of rotation by a second upper hinge, the upper support bar being hinged between at least a third support position in which the upper bar has a third attachment which is adapted to be fastened on a third type of nacelle, and a fourth support position in which the upper bar has a fourth attachment which is adapted to be fastened on a fourth type of nacelle, and in that the second upper axis of rotation is perpendicular to the first upper axis of rotation.

This feature enables the upper bar to adopt at least two additional different positions, in order to adapt to the type of nacelle to handle.

In addition, the first upper hinge includes:

a pivot link which hinges the upper bar relative to the gantry about a first upper axis of rotation, the first axis of rotation extending transversely and perpendicularly to the length of the upper bar; and

an angular indexing device which is designed to block the pivoting of the upper bar in its first support position and its second support position selectively.

The first upper hinge enables a change of the position of the upper bar in a rapid and reliable manner.

Also, the second upper hinge includes:

at least one pivot link which hinges all or part of the upper bar relative to the gantry about the second upper axis of rotation, the second axis of rotation extending longitudinally and along the length of the upper bar; and

an angular indexing device which is designed to block the pivoting of the upper bar in its third support position and its fourth support position selectively.

According to another feature, the upper bar includes a central segment, a distal end segment and a proximal end segment, the distal end segment and the proximal end segment being pivotally mounted on the central segment by the pivot link of the second upper hinge.

According to one form, each of the first attachment which is adapted to be fastened on a first type of nacelle and the second attachment which is adapted to be fastened on a second type of nacelle has the form of a U-shaped clevis which is designed to cooperate with a complementary part of one of said nacelles and an associated locking rod.

According to another feature, the lower support bar is similar to the upper bar, the lower bar is hinged about at least a first lower axis of rotation by a first lower hinge, the lower bar being hinged between at least a first support position in which the lower bar has a first attachment which is adapted to be fastened on the first type of nacelle, and at least a second support position in which the lower support bar has a second attachment which is adapted to be fastened on the second type of nacelle.

Similarly, the lower support bar is hinged about a second lower axis of rotation by a second lower hinge, the lower support bar being hinged between at least a third support position in which the lower bar has a third attachment which is adapted to be fastened on the third type of nacelle, and a fourth support position in which the lower bar has a fourth attachment which is adapted to be fastened on the fourth type of nacelle, and in that the second lower axis of rotation is perpendicular to the first lower axis of rotation.

According to one form, the gantry is equipped with rollers for facilitating the displacement of the gantry.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an overall perspective view of handling tooling according to the present disclosure which carries a nacelle;

FIG. 2 is an overall perspective view of handling tooling according to the present disclosure, without a nacelle;

FIG. 3 is a detail perspective view which illustrates an upper support bar of the tooling of FIG. 1;

FIG. 4 is a detail perspective view which illustrates a first upper hinge of an upper bar of a handling tooling; and

FIG. 5 is a detail perspective view which illustrates a second upper hinge of an upper bar of handling tooling, and an attachment of the upper bar which cooperates with a fastener of a nacelle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

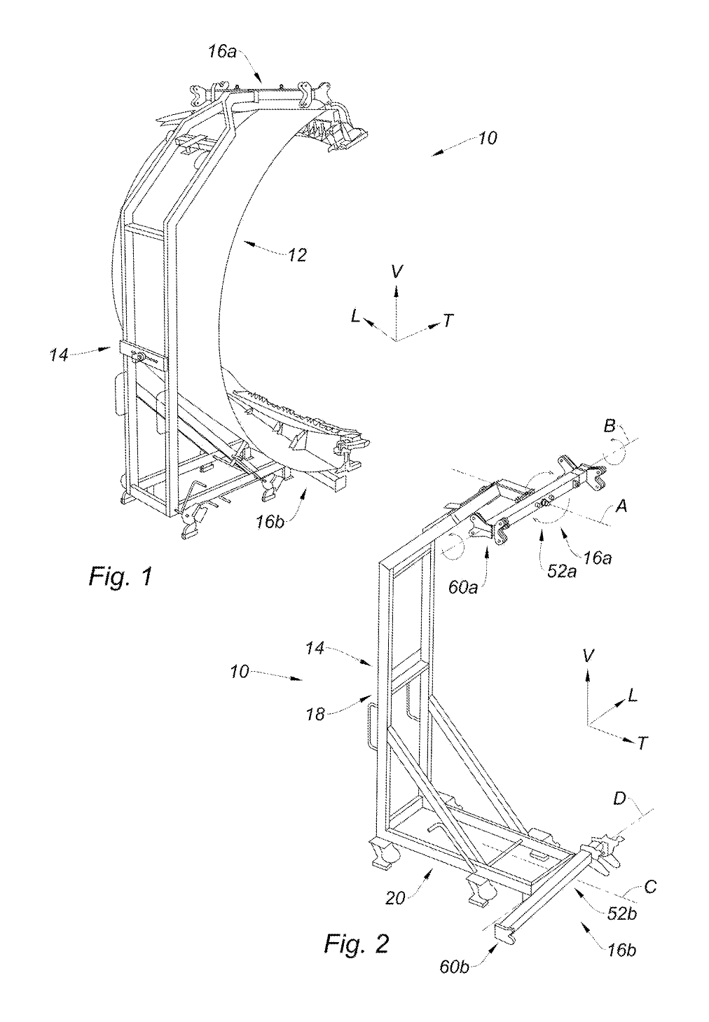

In the description and the claims, in order to clarify the description and the claims, the terms longitudinal, vertical and transverse will be adopted without limitation with reference to the trihedron L, V, T indicated in FIGS. 1-5, whose axis L is parallel to the axis of the nacelle.

In all these figures, identical or similar reference numerals represent identical or similar members or sets of members.

In addition, the terms “upper”, “lower”, “horizontal”, “vertical” and their derivatives refer to the position or to the orientation of an element or of a component, this position or this orientation being considered when the gantry is in service configuration on a horizontal ground.

FIG. 1 represents tooling 10 for handling a nacelle 12 of an aircraft turbojet engine, only a portion of the nacelle 12 is represented in FIG. 1.

Referring to FIG. 2, the tooling 10 mainly comprises a gantry 14, an upper support bar 16a and a lower support bar 16b.

As an indication, for clarity, the reference numerals regarding the upper bar 16a are followed by the letter “a” and the reference numerals regarding the lower bar 16b are followed by the letter “b”.

The gantry 14 is a mechanically-welded type metallic structure having a bracket 18 which is mounted on a base 20 bearing on the ground.

The bracket 18 and the base 20 of the gantry 14 have a generally C-shaped form which is adapted to receive the nacelle 12 at its cavity.

Advantageously, the base 20 is equipped with wheels (not represented) for facilitating the displacement of the tooling 10 on the ground, as well as means (not represented) for stopping the gantry 14.

The upper bar 16a extends longitudinally from an upper free end of the bracket 18 and the lower bar 16b extends longitudinally from a lower free end of the base 20 of the gantry 14, so that the upper bar 16a and the lower bar 16b support an upper part and a lower part of the nacelle 12 respectively.

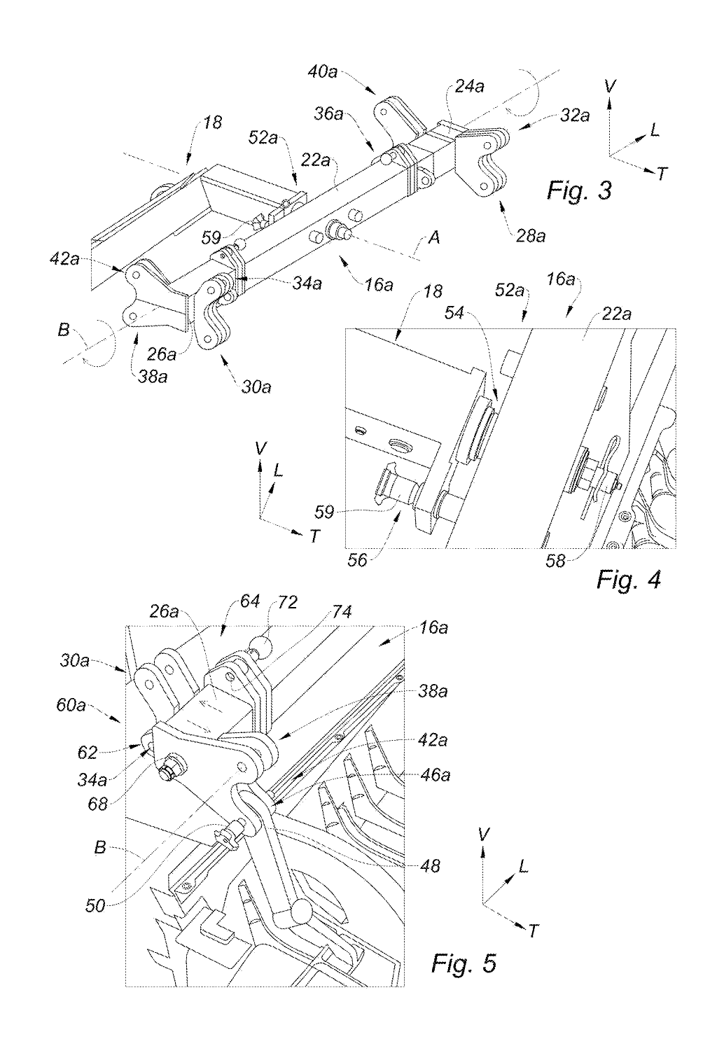

As shown in FIG. 3, the upper bar 16a includes a central segment 22a, a distal end segment 24a and a proximal end segment 26a.

The upper bar 16a includes a first attachment 28a, 30a, the first attachment 28a, 30a comprising a first clevis 28a which is arranged on the distal end segment 24a of the upper bar 16a and a second clevis 30a which is arranged on the proximal end segment 26a of the upper bar 16a.

The clevises 28a, 30a of the first attachment 28a, 30a are aligned along a longitudinal axis so as to cooperate with upper fasteners of a first type of nacelle 12.

In addition, the upper bar 16a includes a second attachment 32a, 34a, the second attachment 32a, 34a comprising a first clevis 32a which is arranged on the distal end segment 24a of the upper bar 16a and a second clevis 34a which is arranged on the proximal end segment 26a of the upper bar 16a.

Similarly, the clevises 32a, 34a of the second attachment 32a, 34a are aligned along a longitudinal axis so as to cooperate with upper fasteners of a second type of nacelle 12.

It should be noted that the clevises 32a, 34a of the second attachment 32a, 34a are superimposed with the clevises 28a, 30a of the first attachment 28a, 30a.

Also, still according to FIG. 3, the upper bar 16a includes a third attachment 36a, 38a, the third attachment 36a, 38a comprising a first clevis 36a which is arranged on the distal end segment 24a of the upper bar 16a and a second clevis 38a which is arranged on the proximal end segment 26a of the upper bar 16a.

The clevises 36a, 38a of the third attachment 36a, 38a are aligned along a longitudinal axis so as to cooperate with upper fasteners of a third type of nacelle.

In addition, the upper bar 16a includes a fourth attachment 40a, 42a, the fourth attachment 40a, 42a comprising a first clevis 40a which is arranged on the distal end segment 24a of the upper bar 16a and a second clevis 42a which is arranged on the proximal end segment 26a of the upper bar 16a.

The clevises 40a, 42a of the fourth attachment 40a, 42a are aligned along a longitudinal axis so as to cooperate with upper fasteners of a fourth type of nacelle.

FIG. 5 represents in detail the second clevis 42a of the fourth attachment 40a, 42a, which is U-shaped and which comprises two ears 44a mounted on the upper bar 16a.

The ears 44a extend parallel to each other and along a transverse direction, the ears 44a delimiting therebetween a slot 46a which is adapted to receive a fastener 48 of a fourth type of nacelle.

Complementarily, the fourth attachment 40a, 42a includes a locking pin 50 which passes longitudinally through the two ears 44a and the associated fastener 48, in order to lock the nacelle on the second clevis 42a of the fourth attachment 40a, 42a.

The clevises 28a, 30a, 32a, 34a, 36a, 38a, 40a of the other attachments are similar to the previously-described clevis 42a, each clevise 28a, 30a, 32a, 34a, 36a, 38a, 40a comprises two ears adapted to cooperate with a complementary fastener of an associated type of nacelle, and therefore will not be described in more detail later in order not to unnecessarily burden the description.

In one form, the upper fasteners of each nacelle are formed by upper fittings of the nacelle, and the lower fasteners of each nacelle, which cooperate with the lower bar 16b, are formed by locks, or lower stirrups, of the nacelle.

According to another aspect, the upper bar 16a is hinged about a first upper transverse axis of rotation A (FIG. 2), between a first support position, illustrated in FIG. 1, in which the first attachment 28a, 30a of the upper bar 16a is arranged to be fastened on the fastener of a first type of nacelle, and a second support position in which the second attachment 32a, 34a of the upper bar 16a is arranged to be fastened on the fastener of a second type of nacelle.

More particularly, the upper bar 16a is adapted to perform a half-turn about the first transverse axis of rotation A, between its first support position and its second support position.

To this end, the tooling 10 includes a first upper hinge 52a, illustrated in FIG. 4, which is formed by a pivot link 54a and an angular indexing device 56a.

The pivot link 54a is made by a rod 58a which extends transversely along the first upper axis of rotation A, from the upper free end of the bracket 18 of the gantry 14, and which passes through the central segment 22a of the upper bar 16a.

Also, the indexing device 56a includes an indexing spring pull-tab 59a which is slidably mounted transversely on a support plate secured to the bracket 18.

The free end of the pull-tab 59a is adapted to cooperate with a first hole and a second hole (not represented) which are delimited by the upper bar 16a in order to block the pivoting of the upper bar 16a in its first support position and its second support position selectively.

Similarly, the upper bar 16a is hinged about a second upper longitudinal axis of rotation B (FIG. 5), between a third support position in which the third attachment 36a, 38a of the upper bar 16a is arranged to be fastened on the fastener of a third type of nacelle, and a fourth support position in which the fourth attachment 40a, 42a of the upper bar 16a is arranged to be fastened on the fastener of a fourth type of nacelle.

More particularly, the distal segment 24a and the proximal segment 26a of the upper bar 16a are adapted to pivot by a half-turn increment about the second longitudinal axis of rotation B, relative to the central segment 22a of the upper bar 16a.

To this end, the tooling 10 includes a second upper hinge 60a, partially illustrated in FIG. 5, which is formed by a pivot link 62a and an angular indexing device 64a.

The pivot link 62a is made by a first rod (not represented) and of a second rod 68a which extend longitudinally along the second upper axis of rotation B, from a first end and a second end of the central segment 22a of the upper bar 16a respectively, the first rod and the second rod 68a forming an axis of rotation of the distal segment 24a and of the proximal segment 26a of the upper bar 16a respectively.

Besides, the indexing device 64a of the second hinge 60a includes a first indexing pull-tab (not represented) and a second indexing spring pull-tab 72a which are slidably mounted longitudinally on the upper bar 16a respectively.

Each of the distal segment 24a and the proximal segment 26a of the upper bar 16a delimits two holes 74a (only one of which is shown in FIG. 5) which are angularly offset by 180 degrees and which are provided to cooperate with the associated pull-tab in order to block the pivoting of the upper bar 16a in its third support position and its fourth support position selectively.

More particularly, the indexing device 64a of the second hinge 60a allows blocking the pivoting of the distal segment 24a and of the proximal segment 26a of the upper bar 16a.

Nonetheless, without limitation, the upper bar 16a may be pivotally mounted about the second axis of rotation B in its entirety.

Similarly, according to a non-represented variant, each of the distal segment 24a and the proximal segment 26a of the upper bar 16a may be designed to adopt more than two angular positions about the associated axis B, for example four distinct positions.

Similarly, the lower support bar 16b is hinged about a first lower transverse axis of rotation C (FIG. 2) by a first lower hinge 52b, the lower bar 16b being hinged between a first support position, represented in FIG. 1, in which the lower bar 16b has a first attachment which is adapted to be fastened on the first type of nacelle, and a second support position in which the lower support bar 16b has a second attachment which is adapted to be fastened on the second type of nacelle.

Also, the lower support bar 16b is hinged about a second lower longitudinal axis of rotation D (FIG. 2) by a second lower hinge 60b, the lower support bar 16b being hinged between a third support position in which the lower bar 16b has a third attachment which is adapted to be fastened on the third type of nacelle, and a fourth support position in which the lower bar 16b has a fourth attachment which is adapted to be fastened on the fourth type of nacelle.

The lower bar 16b of the tooling 10 is similar to the previously described upper bar 16a, and therefore it will not be described in more detail in order not to burden the description.

Nonetheless, unlike the upper bar 16a, the lower bar 16b is adapted to be fastened on lower locks of the associated nacelle, according to the example described herein.

Thus, the attachments of the lower bar 16b are adapted to cooperate with the lower locks of the associated nacelle.

The description of the present disclosure is given as a non-limiting example.

It will be understood that the number of angular positions of the upper bar 16a and of the lower bar 16b about the different axes of rotation are not limited to the example described hereinabove.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. Tooling for handling a nacelle of an aircraft turbojet engine, the tooling comprising:
a gantry comprising:
a longitudinal upper support bar adapted to be fastened on upper fasteners of the nacelle; and
a longitudinal lower support bar adapted to be fastened on lower fasteners of the nacelle,
wherein the upper support bar is hinged about at least a first upper axis of rotation (A) by a first upper hinge between at least a first support position and a second support position,
wherein the upper support bar includes a first attachment adapted to be fastened on a first type of nacelle when in the first support position, and a second attachment adapted to be fastened on a second type of nacelle when in the second support position.

2. The tooling according to claim 1, wherein the first upper hinge comprises:
a pivot link that hinges the upper bar relative to the gantry about the first upper axis of rotation (A), the first axis of rotation (A) extending transversely and perpendicularly to a length of the upper support bar; and
an angular indexing device configured to selectively block pivoting of the upper support bar in its first support position and its second support position.

3. The tooling according to claim 1, wherein the upper support bar is hinged about a second upper axis of rotation (B) by a second upper hinge between at least a third support position and a fourth support position, wherein the upper support bar includes a third attachment adapted to be fastened on a third type of nacelle when in the third support position, and a fourth attachment adapted to be fastened on a fourth type of nacelle when in the fourth support position.

4. The tooling according to claim 3, wherein the second upper axis of rotation (B) is perpendicular to the first upper axis of rotation (A).

5. The tooling according to claim 3, wherein the second upper hinge comprises:
at least one pivot link that hinges all or part of the upper support bar relative to the gantry about the second upper axis of rotation (B), the second axis of rotation (B) extending longitudinally and along a length of the upper support bar; and
an angular indexing device configured to selectively block pivoting of the upper support bar in its third support position and its fourth support position.

6. The tooling according to claim 5, wherein the upper support bar includes a central segment, a distal end segment and a proximal end segment, the distal end segment and the proximal end segment being pivotally mounted on the central segment by the at least one pivot link of the second upper hinge.

7. The tooling according to claim 1, wherein each of the first attachment and the second attachment is a U-shaped clevis configured to cooperate with a complementary part of one of said nacelles and an associated locking rod.

8. The tooling according to claim 1, wherein the lower support bar is hinged about at least a first lower axis of rotation (C) by a first lower hinge between at least a first support position and a second support position, wherein the lower support bar includes a first attachment adapted to be fastened on the first type of nacelle when in the first position, and a second attachment adapted to be fastened on the second type of nacelle when in the second support position.

9. The tooling according to claim 8, wherein the lower support bar is hinged about a second lower axis of rotation (D) by a second lower hinge between at least a third support position and a fourth support position, wherein the lower support bar includes a third attachment is adapted to be fastened on a third type of nacelle when in the third support position, and a fourth attachment is adapted to be fastened on a fourth type of nacelle when in the fourth support position.

10. The tooling according to claim 9, wherein the second lower axis of rotation (D) is perpendicular to the first lower axis of rotation (C).

11. The tooling according to claim 1, wherein the gantry is equipped with rollers for facilitating displacement of the gantry.
